(19) United States
(12) Patent Application Publication
(10) Pub. No.: US 2015/0026932 A1
(43) Pub. Date: Jan. 29, 2015

(54) Double-Layer Open-End Zipper, Double-Layer 3-in-One Open-End Zipper, and Their Fabrication Method

(71) Applicant: Genmore Zipper Corporation, New Taipei City (TW)

(72) Inventor: Lien-Chou Wang, New Taipei City (TW)

(73) Assignee: Genmore Zipper Corporation, New Taipei City (TW)

(21) Appl. No.: 14/082,372

(22) Filed: Nov. 18, 2013

(30) Foreign Application Priority Data
Jul. 29, 2013 (TW) 102127067

(51) Int. Cl. B29D 5/02; A44B 19/02

(52) U.S. Cl. CPC B29D 5/02; A44B 19/02
USPC 24/399; 29/410

(57) ABSTRACT

A double-layer open-end zipper and double-layer 3-in-one open-end zipper and the related fabrication method is disclosed. The double-layer open-end zipper are made by performing a coil spiral and broad-width fabric tape stitching step, a dyeing and drying set, a gapping size setting step, a splitting, folding and calibration step and a glue heating and bonding or stitching step to form a single-sided double-layer zipper chain tape, and then performing a zipper slide coupling step, a ultrasonic patch sealing and T cut hole punching step, a box with small guider and pins with groove fixation step, a zipper slide functioning checking step and a top stop fixation step to obtain the desired finished double-layer open-end zipper.

### BACKGROUND OF THE INVENTION

1. Field of the Invention

The present invention relates to zip fastener technology, and more particularly, to a double-layer open-end zipper and a double-layer 3-in-one open-end zipper and their fabrication method.

2. Description of the Related Art

An open-end zipper has a box and a pin respectively provided at the respective bottom ends of the left and right zipper chain tapes for working with a mating zipper slide. For processing applications, an open-end zipper allows one respective item to be respectively stitched to the left and right zipper tapes. Further, a double-layer zipper has high strength and anti-explosion characteristics. However, making a double-layer zipper in an open-end design needs to perform a gapping size setting procedure prior to the open-end processing process. However, this gapping size setting procedure is complicated. Taiwan Patent Application 10212767, invented by the present inventor, discloses a nylon double-layer zipper fabrication method employing a specially designed gapping size setting technique. Based on this cited invention, the present inventor also creates a double-layer open-end zipper for tent and high-end apparel product applications.

### SUMMARY OF THE INVENTION

The present invention has been accomplished under the circumstances in view. It is the main object of the present invention to provide a double-layer open-end zipper and a double-layer 3-in-one open-end zipper and methods for making the double-layer open-end zipper and the double-layer 3-in-one open-end zipper, wherein the box with small guider and pin with groove have a respective groove for the passing of a tongue-shaped guide plate of the equipped zipper slide, enhancing the sliding smoothness of the zipper slide.

It is another object of the present invention to provide a double-layer open-end zipper and a double-layer 3-in-one open-end zipper and methods for making the double-layer open-end zipper and the double-layer 3-in-one open-end zipper, wherein the double-layer 3-in-one open-end zipper can be used in a tent to let the outer layer protect against rainwater and the inner layer work as a window screen for ventilation, and can also be applied to clothing design for cold and warm applications.

It is another object of the present invention to provide a double-layer open-end zipper and a double-layer 3-in-one open-end zipper and methods for making the double-layer open-end zipper and the double-layer 3-in-one open-end zipper, wherein the double-layer open-end zipper can be equipped with a zipper slide having a tongue-shaped guide plate at a center block thereof to provide a safety anti-explosion function.

### BRIEF DESCRIPTION OF THE DRAWING

FIG. 1 is a double-layer open-end zipper manufacturing flow chart in accordance with the present invention.

FIG. 2 is a schematic plain view, illustrating a zipper slide coupled to the interlocking teeth of a double-layer open-end zipper made according to the present invention.

FIG. 3 is an elevational view of a box with small guider for double-layer open-end zipper in accordance with the present invention.

FIG. 4 is an elevational view of a pin with groove for double-layer open-end zipper in accordance with the present invention.

FIG. 5 is a schematic top elevational view illustrating the positioning of the box with small guider in one zipper chain tape of the double-layer open-end zipper in accordance with the present invention.

FIG. 6 is a side view of FIG. 5.

FIG. 7 is a schematic top elevational view illustrating the positioning of the pin with groove in one zipper chain tape of the double-layer open-end zipper in accordance with the present invention.

FIG. 8 is a side view of FIG. 7.

FIG. 9 is a schematic drawing illustrating the pin with groove at one zipper chain tape of the double-layer open-end zipper inserted into the zipper slide in accordance with the present invention.

FIG. 10 is a schematic top assembly view of the double-layer open-end zipper in accordance with the present invention.

FIG. 11 is an elevational assembly view of a part of the double-layer open-end zipper in accordance with the present invention, illustrating two pins with groove inserted into the box with small guider.

FIG. 12 is a front plain view of the box with small guider shown in FIG. 3.

FIG. 13 is a schematic drawing of a part of the double-layer open-end zipper manufacturing flow in accordance with the present invention.

FIG. 14 is a schematic front plain view of a part of the double-layer open-end zipper manufacturing flow in accordance with the present invention, illustrating the procedure of the setting of the gapping size of the zipper chain tape.

FIG. 15 is a schematic side plain view of a part of the double-layer open-end zipper manufacturing flow in accordance with the present invention, illustrating the procedure of the setting of the gapping size of the zipper chain tape.

FIG. 16 is a double-layer 3-in-one open-end zipper manufacturing flow chart in accordance with the present invention.

FIG. 17 is a schematic plain view, illustrating a zipper slide coupled to the interlocking teeth of a double-layer 3-in-one open-end zipper made according to the present invention.

FIG. 18 is an elevational assembly view of a part of the double-layer 3-in-one open-end zipper in accordance with the present invention, illustrating two pins with groove inserted into the box with small guider.

FIG. 19 illustrates the arrangement of upper and bottom pins with groove for use in a double-layer 3-in-one open-end zipper in accordance with the present invention.

FIG. 20 is a front plain view of the upper and bottom pins with groove shown in FIG. 19.

### DETAILED DESCRIPTION OF THE INVENTION

The invention provides a double-layer open-end zipper and a double-layer 3-in-one open-end zipper. The invention also provides a method for making double-layer open-end zippers double-layer 3-in-one open-end zippers.

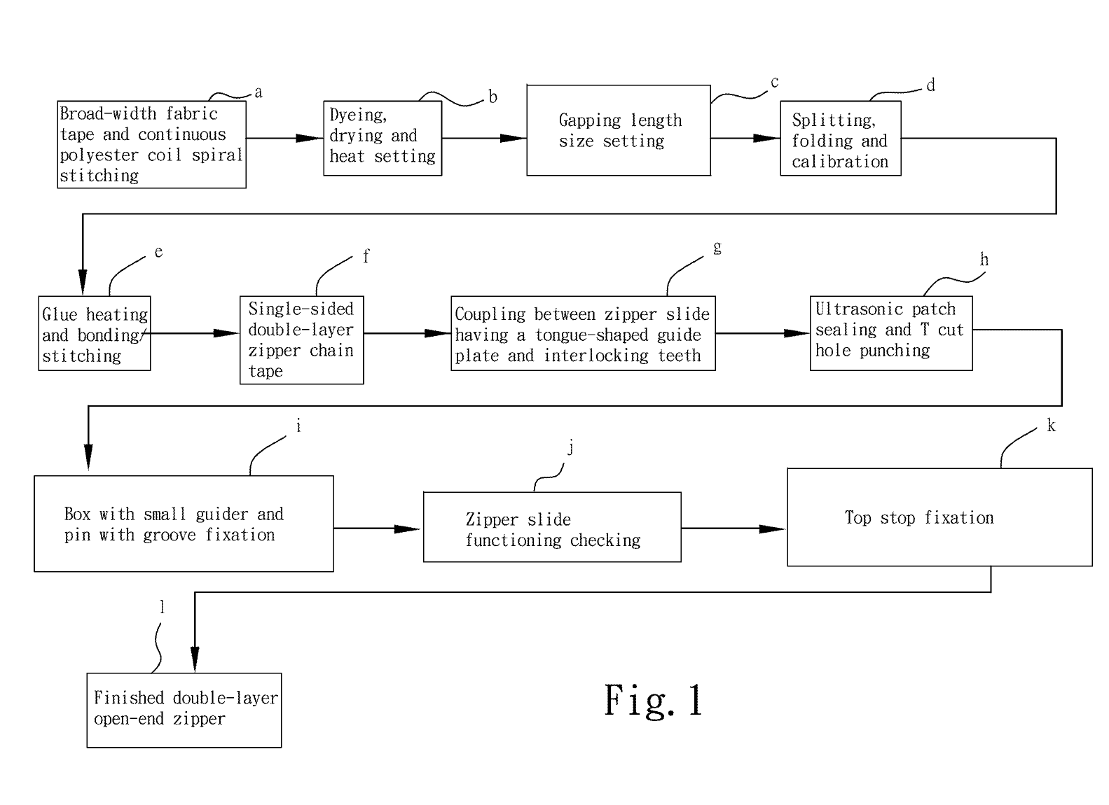

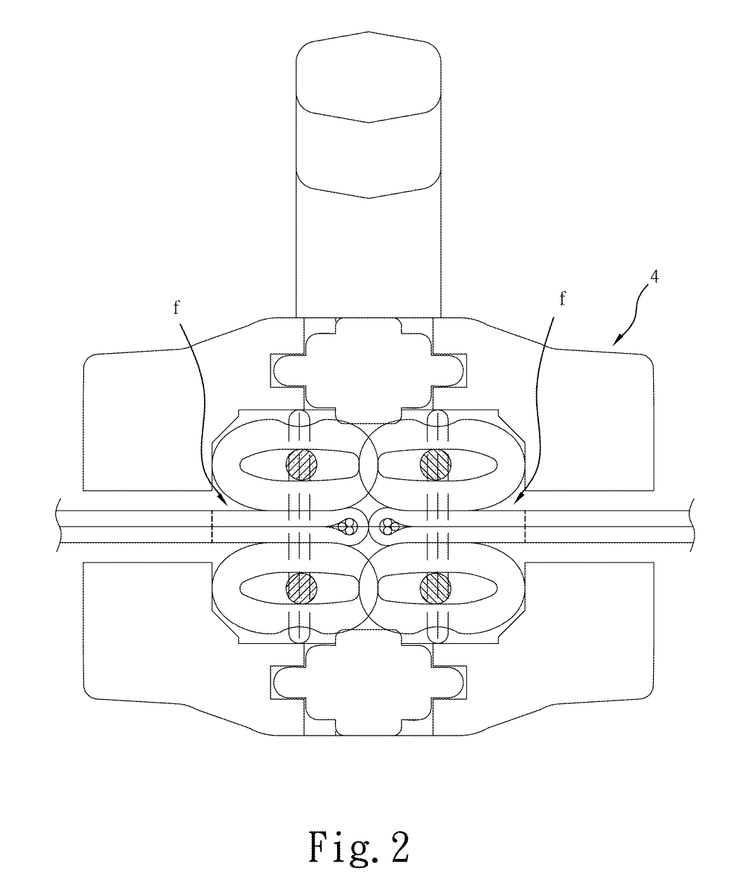

Referring to FIG. 1, a zipper fabrication method for making a double-layer open-end zipper in accordance with the present invention is outlined hereinafter.

1. At first, stitch a continuous polyester coil spiral to a broad-width fabric tape to form a zipper chain tape having integrated opposing left and right series of interlocking teeth (step a), and then employ dyeing and drying processes to dye the zipper chain tape and to dry the colored zipper chain tape and to set it in shape by heating (step b), and then use an electronic or mechanical tooth-counting apparatus to count the number of teeth and to set the gapping size of the zipper chain tape (step c) where an electronic tooth-counting apparatus, or a mechanical tooth-counting apparatus working like the functioning between a gear and tooth rack (zipper chain tape is a kind of tooth rack) is used with sensors to count the number of teeth of the zipper chain tape being moved, and to stop the zipper chain tape conveying system from delivering the zipper chain tape when the counted number of teeth reaches the predetermined set value, and also to control the operation of a cutter in pre-cutting the zipper chain tape subject to a predetermined length range before the counted number of teeth reaches the predetermined set value (step c), and then use a splitter to separate the integrated left and right series of interlocking teeth of the zipper chain tape, and then use a folding and calibration guide device to fold up the glued zipper chain tape and to correct the interlocking teeth (step d), and then secure the folded zipper chain tape in the folded condition using a glue heating and bonding technique or stitching technique (step e), and thus a single-sided double-layer zipper chain tape is obtained (step f).

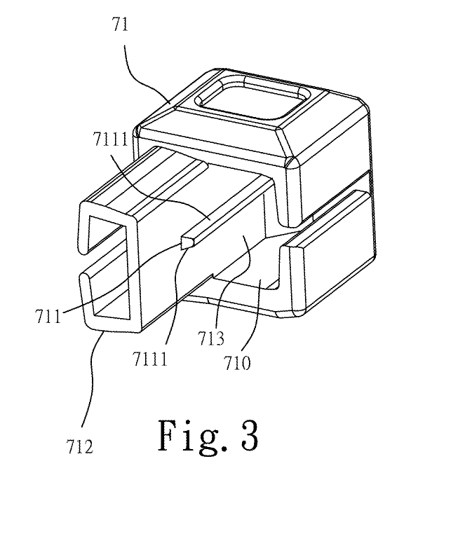

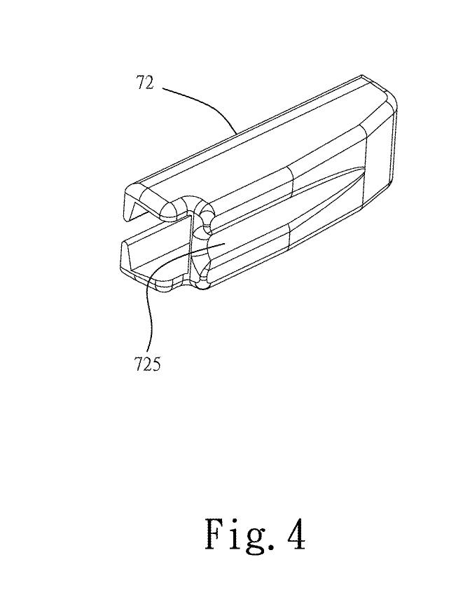

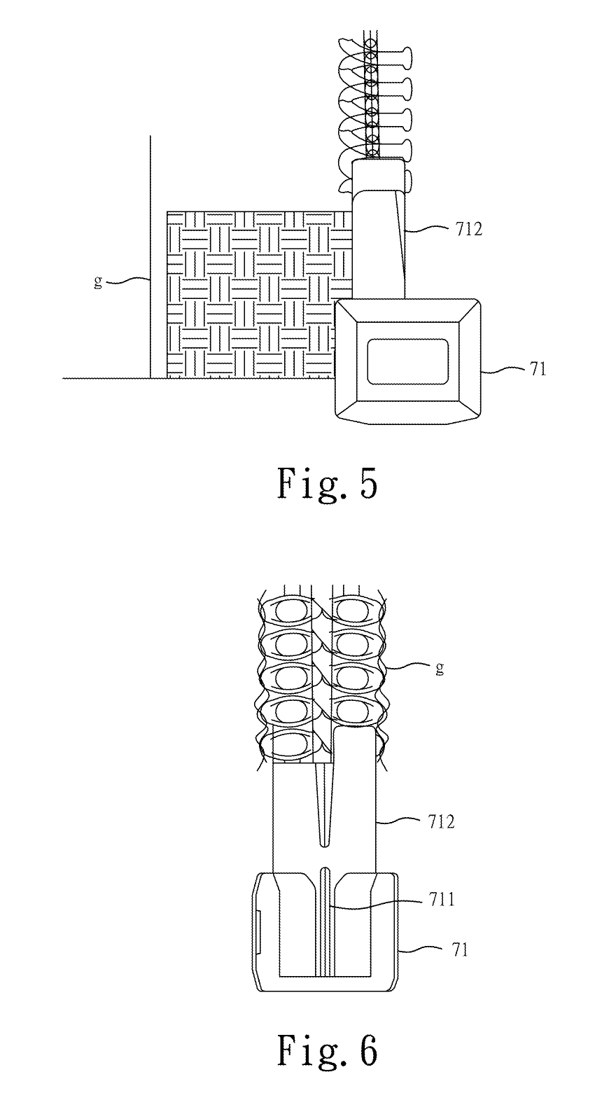

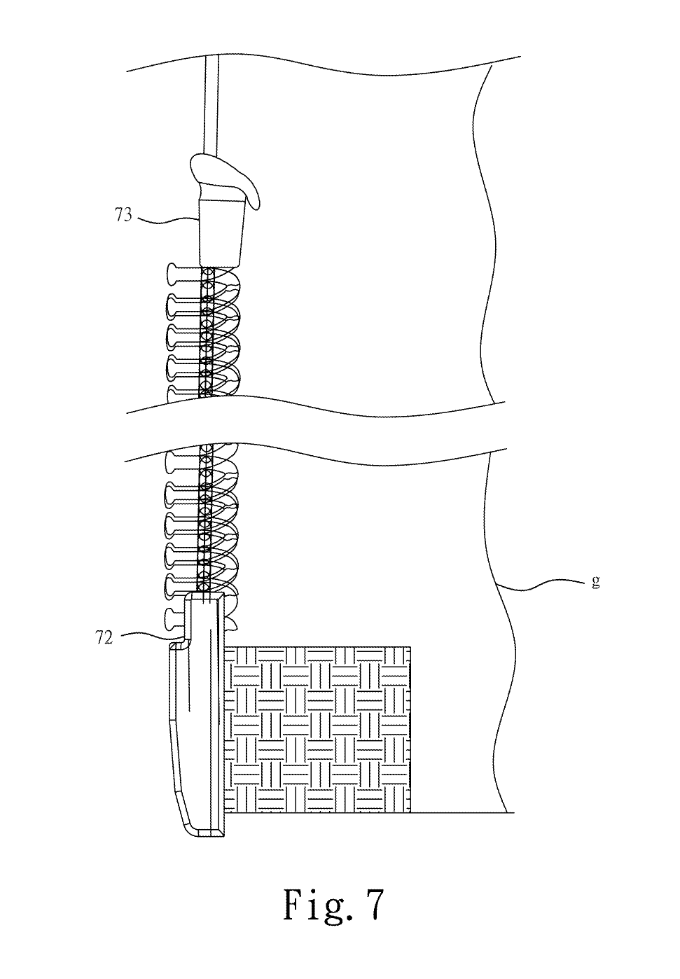

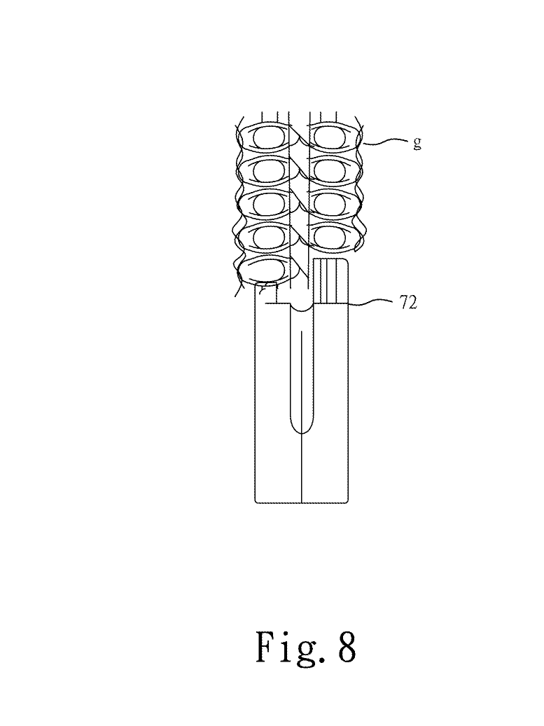

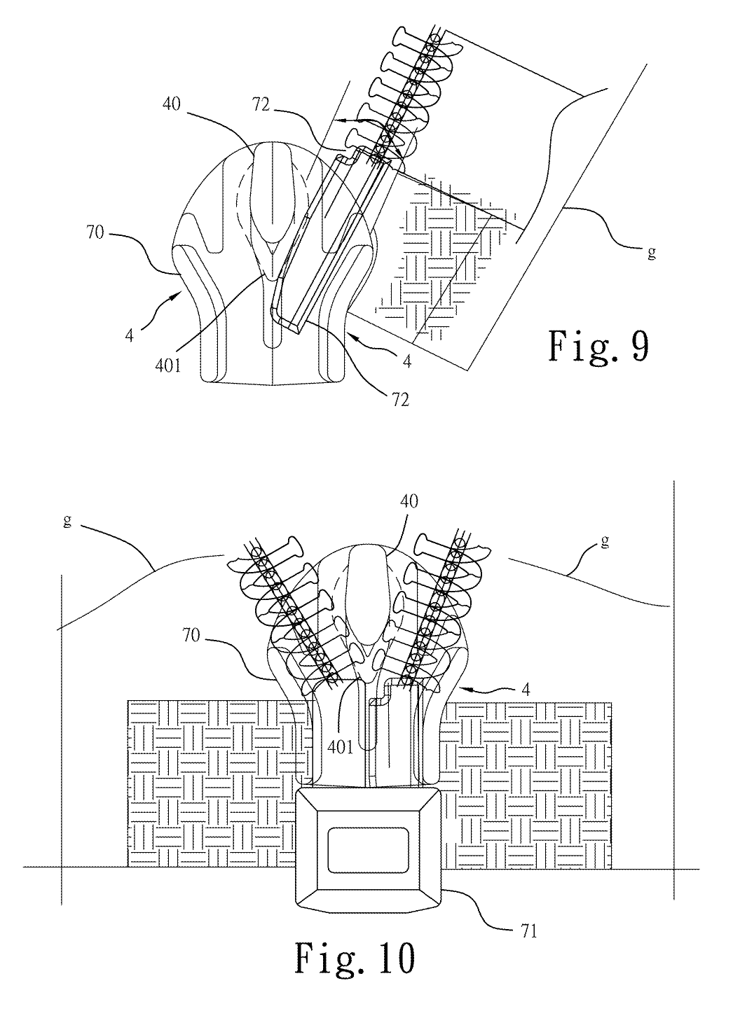

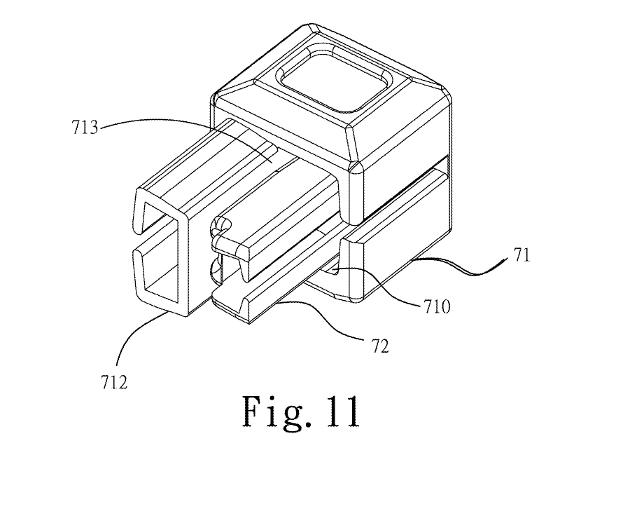

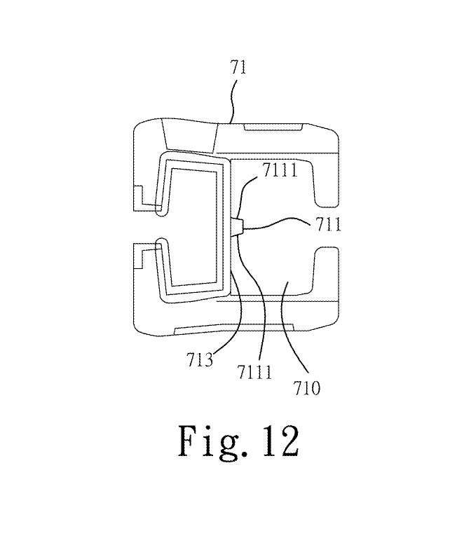

2. After obtained one single-sided double-layer zipper chain tape (step f), attach a zipper slide having a tongue-shaped guide plate at a center block thereof or a roller zipper slide 4 (prepared according to U.S. Pat. No. 8,381,369 or Taiwan Utility No. M407651 that is issued to the present inventor) to the interlocking teeth of two single-sided double-layer zipper chain tapes (step g), and then perform a ultrasonic patch sealing and T cut hole punching step (step h), and then employ a stamping technique to affix a box with small guider 71 (see FIG. 3) and a pin with groove 72 (see FIG. 4) to the bottom side of the double-layer zipper chain tape (step i) (see FIGS. 5-8), and then operate the zipper slide 4 to check the sliding smoothness of the zipper slide and the functioning of the double-layer zipper chain tape (step j) (see FIGS. 9 and 10) so as to complete the processing of the open end of the double-layer zipper chain tape (the aforesaid box with small guider 71 and pin with groove 72 are made of a plastic material by injection molding and respectively affixed to respective bottom ends of the left and right fabric tapes of the single-sided double-layer zipper chain tape), and then employ a stamping or injection-molding technique to affix a top stop 73 (see FIG. 7) to one respective end tooth at the opposing top end of each fabric tape of the double-layer zipper chain tape (step k), and thus a double-layer open-end zipper 1 is obtained (step l). When the interlocking teeth of the upper and bottom layers of the double-layer open-end zipper are closed, the double-layer open-end zipper provides a safety anti-explosion function. Further, the aforesaid box with small guider 71 and pin with groove 72 have a respective groove 7111 or 725 (see FIG. 3 and FIG. 4) for the passing of the tongue-shaped guide plate 401 at a center block 40 of the zipper slide 4 during insertion (see FIG. 9) to provide a guiding function, enhancing the sliding smoothness of the zipper slide.

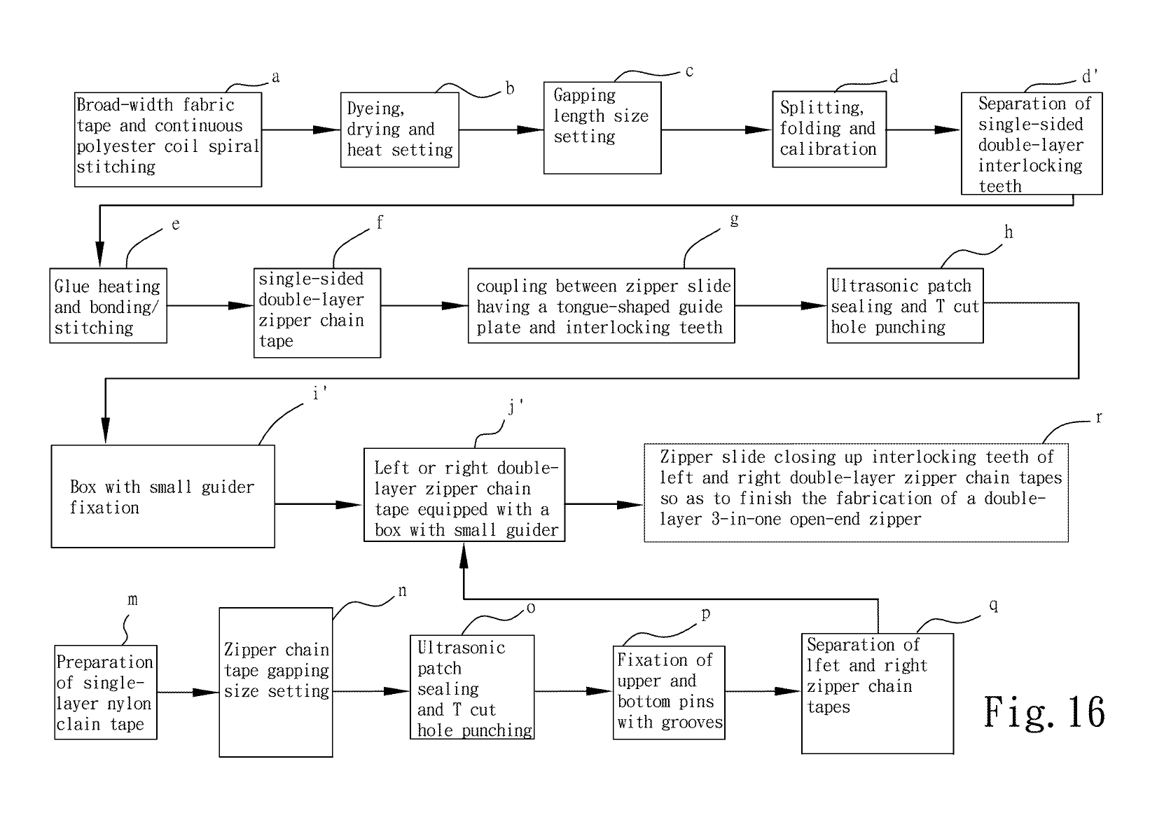

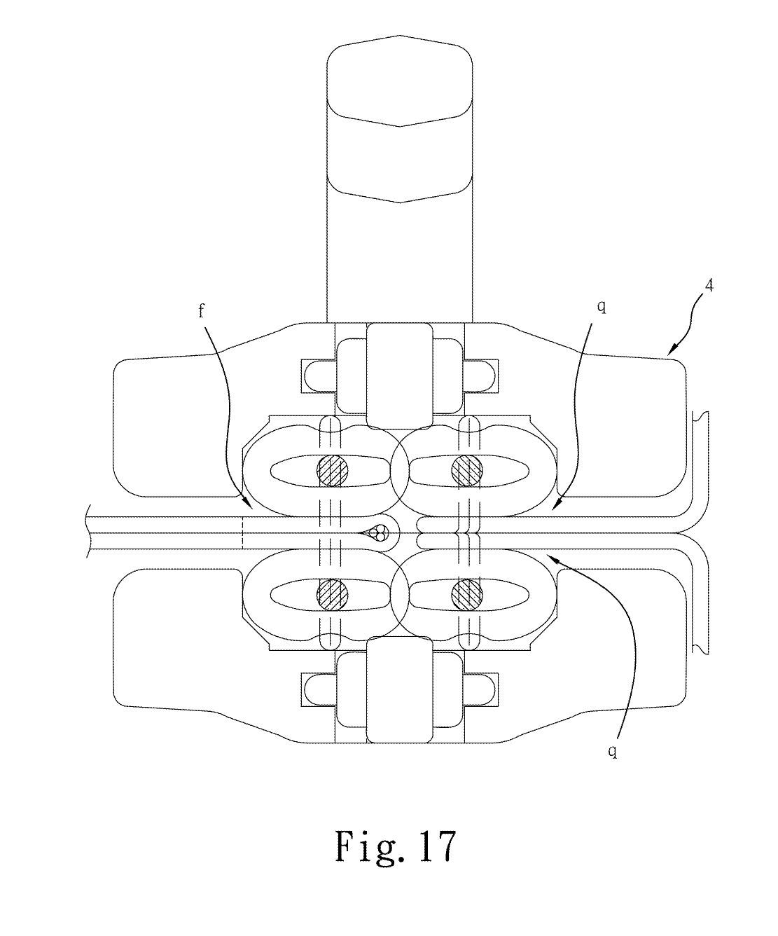

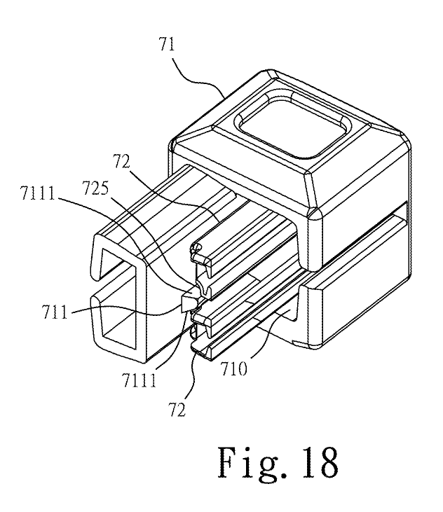

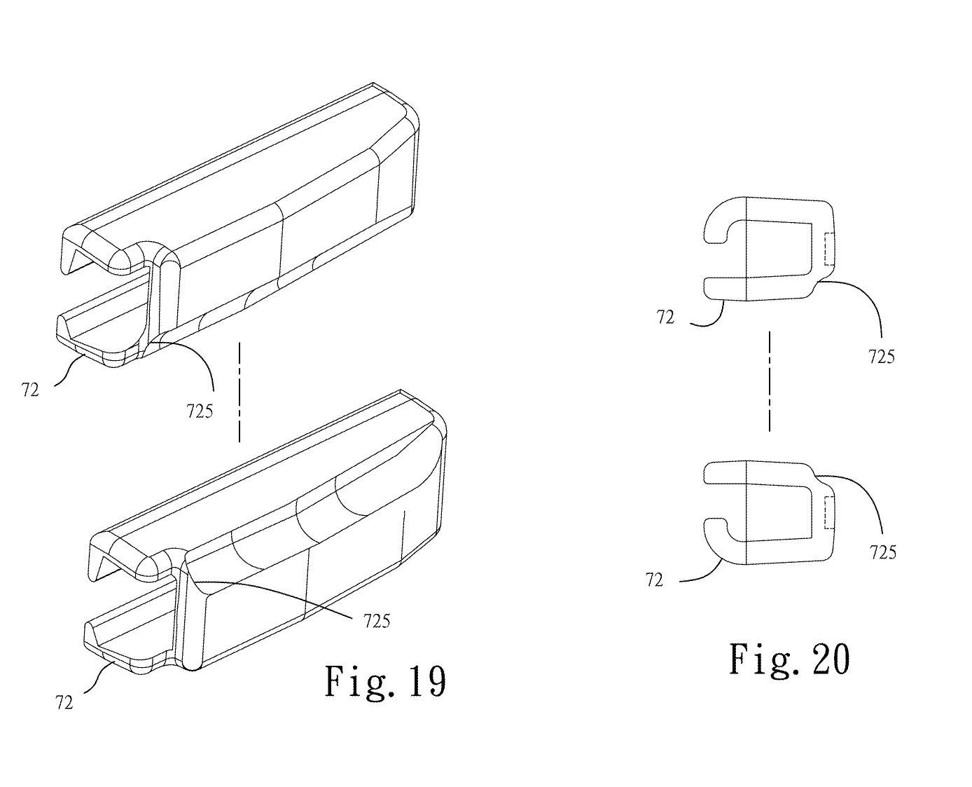

3. A zipper fabrication method for making a double-layer 3-in-one open-end zipper in accordance with the present invention, as shown in FIG. 16, is outlined hereinafter. At first, stitch a continuous polyester coil spiral to a broad-width fabric tape to form a zipper chain tape having integrated opposing left and right series of interlocking teeth (step a), and then employ dyeing and drying processes to dye the zipper chain tape and to dry the colored zipper chain tape and to set it in shape by heating (step b), and then use an electronic or mechanical tooth-counting apparatus to count the number of teeth and to set the gapping size of the zipper chain tape (step c), and to stop the zipper chain tape conveying system from delivering the zipper chain tape when the counted number of teeth reaches the predetermined set value, and also to control the operation of a cutter in pre-cutting the zipper chain tape subject to a predetermined length range before the counted number of teeth reaches the predetermined set value (step c), and then use a splitter to separate the integrated left and right series of interlocking teeth of the zipper chain tape, and then use a folding and calibration guide device to fold up the glued zipper chain tape and to correct the interlocking teeth (step d), and then separate the teeth to form single-sided double-layer interlocking teeth (step d′), and then secure the folded zipper chain tape in the folded condition using a glue heating and bonding technique or stitching technique (step e) so as to obtain a single-sided double-layer zipper chain tape (step f), and then attach a zipper slide having a tongue-shaped guide plate at a center block thereof to the interlocking teeth of two single-sided double-layer zipper chain tapes (step g), and then perform a ultrasonic patch sealing and T cut hole punching step (step h), and then set a box with small guider to the bottom end of the left or right-sided double-layer zipper chain tape (step i′) to have the left or right-sided double-layer zipper chain tape be equipped with a box with small guider (step j′), and then operate the tongue-shaped guide plate configured zipper slide to close up the interlocking teeth of the left and right double-layer zipper chain tapes so as to finish the fabrication of a double-layer 3-in-one open-end zipper (step r). According to this embodiment, the box with small guider, referenced by 71, can be a metal box or plastic box affixed to the end tooth at the bottom end of each left or right fabric tape of the single-sided double-layer zipper chain tape. Referring also to FIG. 3, the box with small guider 71 comprises a receiving hole 710 for receiving mating pins with groove, a protruding column 712 having a sidewall 713 facing toward the receiving hole 710, a guide rail 711 located on a middle part of the sidewall 713 for guiding the upper and bottom pins with groove 72 at the upper and bottom sides of a left or right-sided single-layer zipper chain tape into the receiving hole 710 (see also FIG. 18). The said guide rail 711 can extend longitudinally and shorten vertically when needed. Please refer to FIGS. 9, 18, 19 and 20, the aforesaid upper and bottom pins with groove 72 each comprise a groove 725 for the passing of the tongue-shaped guide plate 401 at the center block 40 of the zipper slide 4 during insertion to provide a guiding function, enhancing the sliding smoothness of the zipper slide. The fabrication of the aforesaid left or right fabric tape with upper and bottom pins with groove (q) is explained hereinafter with reference to FIG. 16. A waterproof strip 45 molded on the said left or right fabric tape or waterproof glue can applied on said fabric tape. At first, prepare a single-layer nylon chain tape (step m), and then use an electronic or mechanical tooth-counting apparatus to count the number of teeth and to set the gapping size of the zipper chain tape (step n), and then perform a ultrasonic patch sealing and T cut hole punching step (step o), and then affix upper and bottom pins with groove to each of left and right zipper chain tapes (step p), and then separate the left zipper chain tape and the right zipper chain tape (step q). After the upper and bottom pin with groove 72 of the left and right zipper chain tape have been respectively inserted into the receiving hole 710 of the box with small guider 71, the tongue-shaped guide plate configured zipper slide is operated to close up the interlocking teeth of the left and right double-layer zipper chain tapes, and thus the fabrication of a double-layer 3-in-one open-end zipper is done (step r). A double-layer 3-in-one open-end zipper of the invention is practical for use in a tent where the outer layer works to protect against rainwater, and the inner layer works as a window screen for ventilation. This design of double-layer 3-in-one open-end zipper can also be applied to clothing design for cold and warm applications.

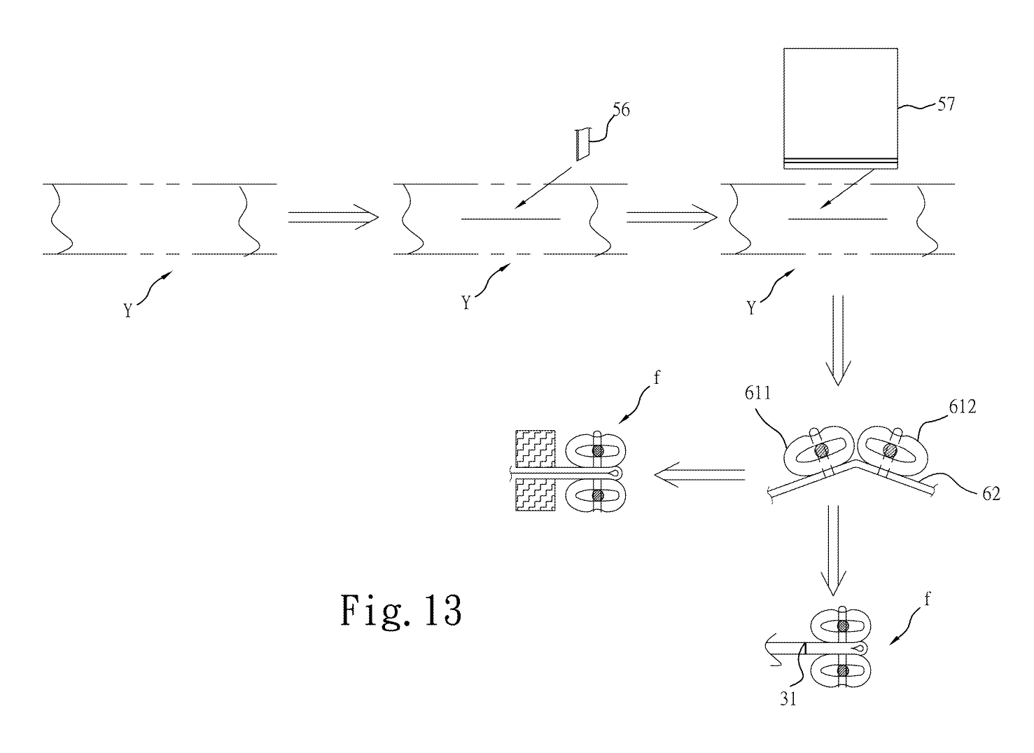

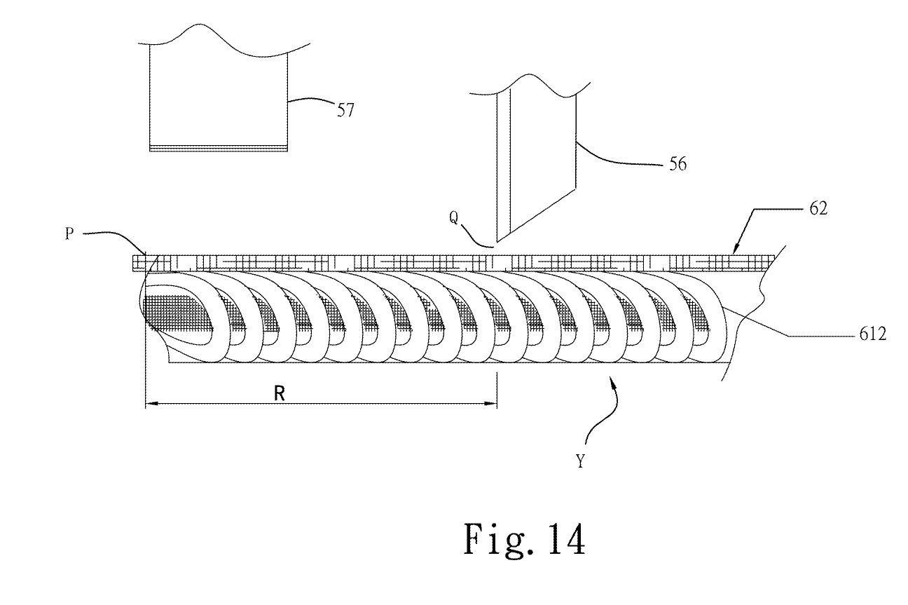

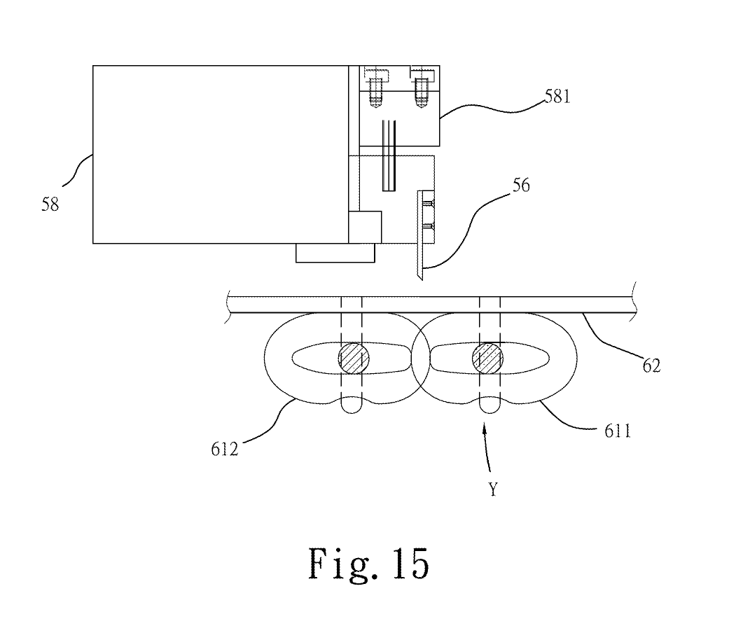

The step of using an electronic or mechanical tooth-counting apparatus to count the number of teeth and to set the size of the zipper chain tape (step c or step n) is explained hereinafter. A pneumatic cylinder 581 carried on a cutter base 58 is controlled to reciprocate a cutter blade 56 up and down prior to die punching (see FIGS. 13-15). The cutter blade 56 can be a utility knife or razor moved to cut a cut line on the back wall of the broad-width fabric tape 62 of the prepared single-layer zipper chain tape Y opposite to the continuous polyester coil spiral. The cutting length is equal to or slightly larger than the width of the punch die 57 (see FIG. 13). At this time, an electronic counting and pitch parameter value control system is adopted. After setting of the digital values in the tooth reading implement subject to the client's desired gapping size, the cutter base 58 carrying the pneumatic cylinder 581 is set in position, and then the pneumatic cylinder 581 is controlled to reciprocate the cutter blade 56 up and down. The cutter base 58 can be moved forward or backward to the desired position. If the gapping size is 20 inches=200 pitches, i.e., pitches of N1 times, the distance R between the point P corresponding to the front cutting edge of the punch die 57 and the point Q corresponding to the lowest point of the cutter blade 56 is 20 pitches, i.e., pitches of N2 times, the circuit of the tooth reading implement is set in a continuous mode, i.e., when reaches 200−20=180 pitches, i.e., pitches of N1 times minus pitches of N2 times equal to pitches of N3 times, the cutter blade 56 is then lowered to cut the broad-width fabric tape 62 subject to the width of the punch die 57, and then the cutter blade 56 is lifted, and then the punch die 57 is moved down to punch the continuous polyester coil spiral into opposing left and right series of interlocking teeth when counting of 200 pitches, i.e., pitches of N1 times is up.

Furthermore, in the step of using a folding and calibration guide device to fold up the glued zipper chain tape and to correct the interlocking teeth (step d), left and right series of interlocking teeth 611, 612 of the single-layer zipper chain tape Y are split, and then a folding and interlocking teeth calibrating process is performed, and then a glue heating and bonding procedure or stitching procedure is performed (step e) so as to obtain a single-sided double-layer zipper chain tape (step f; see also FIG. 13). The glue heating and bonding procedure or stitching procedure is performed to bond the upper and lower fabric tapes 62 of the single-sided double-layer chain tape together with a bonding glue, or to stitch the upper and lower fabric tapes 62 of the single-sided double-layer chain tape along their outer side edges 31 (see also FIG. 13). The said procedure allows the customer to stitch easily.

In conclusion, the invention provides a waterproof, airtight, anti-slit, high transverse tensile strength double-layer zipper that has advantages and features as follows:
1. A double-layer 3-in-one open-end zipper of the invention can be used in a tent where the outer layer works to protect against rainwater and the inner layer works as a window screen for ventilation, and can also be applied to clothing design for cold and warm applications.
2. The box with small guider 71 of the double-layer 3-in-one open-end zipper of the invention comprises a receiving hole 710 for receiving the upper and bottom pins with groove 72 of the left or zipper chain tape, and the upper and bottom pins with groove 72 each comprise a groove 725 for the passing of the tongue-shaped guide plate 401 at the center block 40 of the zipper slide 4 to provide a guiding function and to enhance the sliding smoothness of the zipper slide.
3. After the interlocking teeth of the upper and bottom layers are closed, the double-layer open-end zipper of the present invention effectively provides a safety anti-explosion function.
4. The box with small guider 71 and pin with groove 72 of the double-layer open-ended zipper have a respective groove 7111 or 725 for the passing of the tongue-shaped guide plate 401 at a center block 40 of the zipper slide 4 to provide a guiding function, enhancing the sliding smoothness of the zipper slide.
5. The cutter blade 56 can be controlled to cut a cut line on the back wall of the broad-width fabric tape 62 of the prepared single-layer zipper chain tape Y opposite to the continuous polyester coil spiral according to the width of the punch die 57, enabling the punch die 57 to punch the continuous polyester coil spiral into opposing left and right series of interlocking teeth accurately and efficiently without causing damage, saving much labor and operating time and reducing punch die maintenance cost.

What is claimed is:

1. A zipper fabrication method for making a double-layer 3-in-one open-end zipper, comprising the steps of:
stitching a continuous polyester coil spiral to a broad-width fabric tape to form a zipper chain tape having integrated opposing left and right series of interlocking teeth;
employing dyeing and drying processes to dye said zipper chain tape and to dry the colored said zipper chain tape and to set the colored said zipper chain tape in shape by heating;
using an electronic or mechanical tooth-counting apparatus to count the number of teeth of the series of interlocking teeth of said zipper chain tape and to set the gapping size of said zipper chain tape, where a pneumatic cylinder carried on a cutter base is controlled to reciprocate a cutter blade up and down prior to die punching and to cut a cut line on a back wall of the broad-width fabric tape of the prepared single-layer zipper chain tape opposite to the continuous polyester coil spiral approximately equal to the width of a predetermined punch die, and an electronic counting and pitch parameter value control system is used at this time, after setting of the digital values in the tooth reading implement subject to the desired gapping size, said cutter base carrying said pneumatic cylinder being set in position, and then said pneumatic cylinder being controlled to reciprocate said cutter blade up and down, said cutter base being movable forward or backward to the desired position, the distance between the point corresponding to a front cutting edge of said punch die and the point corresponding to the lowest point of said cutter blade being pitches of N2 times when the set gapping size is pitches of N1 times, the circuit of the tooth reading implement is set in a continuous mode, i.e., when reaches pitches of N1 times minus pitches of N2 times equal to pitches of N3 times, said cutter blade is lowered to cut said broad-width fabric tape subject to the width of said punch die, and then said cutter blade is lifted, and then said punch die is moved down to punch the continuous polyester coil spiral into opposing left and right series of interlocking teeth when counting of pitches of N1 times is up;
using a splitter to separate the integrated left and right series of interlocking teeth of said zipper chain tape, and then using a folding and calibration guide device to fold up the glued said zipper chain tape and to correct the interlocking teeth;
separating the teeth to form single-sided double-layer interlocking teeth;
securing the folded zipper chain tape in the folded condition using a glue heating and bonding technique or stitching technique to obtain a single-sided double-layer zipper chain tape;
attaching a zipper slide having a tongue-shaped guide plate at a center block thereof to the interlocking teeth of two said single-sided double-layer zipper chain tapes;
performing a ultrasonic patch sealing and T cut hole punching step;
setting a box with small guider to a bottom end of left or right-sided double-layer zipper chain tape thus obtained to have the left or right-sided double-layer zipper chain tape be equipped with a box with small guider, said box with small guider comprising a receiving hole for receiving mating pins with groove, a protruding column having a sidewall facing toward said receiving hole, a guide rail located on a middle part of said sidewall for guiding upper and bottom pins with groove at the upper and bottom sides of a left or right-sided single-layer zipper chain tape into said receiving hole, said upper and bottom pins with groove each comprising a groove for the passing of the tongue-shaped guide plate at the center block of the zipper slide; and
operating the tongue-shaped guide plate configured zipper slide to close up the interlocking teeth of the left and right double-layer zipper chain tapes so as to finish the fabrication of a double-layer 3-in-one open-end zipper.

2. The zipper fabrication method for making a double-layer 3-in-one open-end zipper as claimed in claim 1, wherein said upper and bottom pins with groove each comprise a respective groove for the passing of said tongue-shaped guide plate at said center block of said zipper slide to provide a guiding function.

3. The zipper fabrication method for making a double-layer 3-in-one open-end zipper as claimed in claim 1, wherein in the step of using a splitter to separate the integrated left and right series of interlocking teeth of said zipper chain tape, and then using a folding and calibration guide device to fold up the glued said zipper chain tape and to correct the interlocking teeth, a folding and calibration guide device is used to fold up the glued zipper chain tape and to correct the interlocking teeth by: splitting left and right series of interlocking teeth of the single-layer zipper chain tape, and then performing a folding and interlocking teeth calibrating process; the step of securing the folded zipper chain tape in the folded condition using a glue heating and bonding technique or stitching technique to obtain a single-sided double-layer zipper chain tape is to bond upper and lower fabric tapes of the single-sided double-layer chain tape together with a bonding glue, or to stitch upper and lower fabric tapes of the single-sided double-layer chain tape along respective outer side edges thereof.

4. A zipper fabrication method for making a double-layer open-end zipper, comprising the steps of:
stitching a continuous polyester coil spiral to a broad-width fabric tape to form a zipper chain tape having integrated opposing left and right series of interlocking teeth;
employing dyeing and drying processes to dye said zipper chain tape and to dry the colored said zipper chain tape and to set the colored said zipper chain tape in shape by heating;
using an electronic or mechanical tooth-counting apparatus to count the number of teeth of the series of interlocking teeth of said zipper chain tape and to set the gapping size of said zipper chain tape, where a pneumatic cylinder carried on a cutter base is controlled to reciprocate a cutter blade up and down prior to die punching and to cut a cut line on a back wall of the broad-width fabric tape of the prepared single-layer zipper chain tape opposite to the continuous polyester coil spiral approximately equal to the width of a predetermined punch die, and an electronic counting and pitch parameter value control system is used at this time, after setting of the digital values in the tooth reading implement subject to the desired gapping size, said cutter base carrying said pneumatic cylinder being set in position, and then said pneumatic cylinder being controlled to reciprocate said cutter blade up and down, said cutter base being movable forward or backward to the desired position, the distance between the point corresponding to a front cutting edge of said punch die and the point corresponding to the lowest point of said cutter blade being pitches of N2 times when the set gapping size is pitches of N1 times, the circuit of the tooth reading implement is set in a continuous mode, i.e., when reaches pitches of N1 times minus pitches of N2 times equal to pitches of N3 times, said cutter blade is lowered to cut said broad-width fabric tape subject to the width of said punch die, and then said cutter blade is lifted, and then said punch die is moved down to punch the continuous polyester coil spiral into opposing left and right series of interlocking teeth when counting of pitches of N1 times is up;
using a splitter to separate the integrated left and right series of interlocking teeth of the zipper chain tape;
using a folding and calibration guide device to fold up the zipper chain tape and to correct the interlocking teeth;
securing the folded zipper chain tape in the folded condition using a glue heating and bonding technique or stitching technique so as to obtain a single-sided double-layer zipper chain tape;
attaching a zipper slide having a tongue-shaped guide plate at a center block thereof or a roller zipper slide to the interlocking teeth of two single-sided double-layer zipper chain tapes thus made;
performing a ultrasonic patch sealing and T cut hole punching step;
employing a stamping technique to affix a box with small guider and a pin with groove to a bottom side of the double-layer zipper chain tape thus obtained;
operating said zipper slide to check the sliding smoothness of said zipper slide and the functioning of said double-layer zipper chain tape; and
employing a stamping or injection-molding technique to affix a top stop to one respective end tooth at an opposing top end of each fabric tape of said double-layer zipper chain tape so as to obtain a finished double-layer open-end zipper.

5. The zipper fabrication method for making a double-layer open-end zipper as claimed in claim 4, wherein said box with small guider and said pin with groove have a respective groove for the passing of the tongue-shaped guide plate at the center block of said zipper slide during insertion.

6. The zipper fabrication method for making a double-layer open-end zipper as claimed in claim 4, wherein in the step of using a splitter to separate the integrated left and right series of interlocking teeth of said zipper chain tape, and then using a folding and calibration guide device to fold up the glued said zipper chain tape and to correct the interlocking teeth, a folding and calibration guide device is used to fold up the glued zipper chain tape and to correct the interlocking teeth by: splitting left and right series of interlocking teeth of the single-layer zipper chain tape, and then performing a folding and interlocking teeth calibrating process; the step of securing the folded zipper chain tape in the folded condition using a glue heating and bonding technique or stitching technique to obtain a single-sided double-layer zipper chain tape is to bond upper and lower fabric tapes of the single-sided double-layer chain tape together with a bonding glue, or to stitch upper and lower fabric tapes of the single-sided double-layer chain tape along respective outer side edges thereof.

7. A double-layer open-end zipper, comprising a single-sided double-layer zipper chain tape, a zipper slide for closing/opening interlocking teeth of said single-sided double-layer zipper chain tape, said zipper slide comprising a center block and a tongue-shaped guide plate extended from said center block, and a box with small guider and a pin with groove made of a plastic material by injection molding and respectively affixed to respective bottom ends of left and right fabric tapes of said single-sided double-layer zipper chain tape, wherein said box with small guider and pin with groove said have a respective groove for the passing of said tongue-shaped guide plate of said zipper slide.

8. A double-layer 3-in-one open-end zipper, comprising:
a left or right single-sided double-layer zipper chain tape, a metal box or plastic box affixed to a bottom end of said left or right single-sided double-layer zipper chain tape, said box with small guider comprising a receiving hole for receiving mating upper and bottom pins with groove, a protruding column having a sidewall facing toward said receiving hole, and a guide rail located on a middle part of said sidewall for guiding inserted mating upper and bottom pins with groove; and
a left/right single-layer zipper tape each having upper and bottom pins with groove each located at a bottom end thereof for inserting into said receiving hole of said box with small guider.
